(19) United States
(12) Patent Application Publication
(10) Pub. No.: US 2012/0140373 A1
(43) Pub. Date: Jun. 7, 2012

(54) APPARATUS AND METHOD FOR GENERATING ELECTRIC DISCHARGE IN LIQUID USING GAS JET

(75) Inventors: Yun Sik JIN, Gyeongsangnam-do (KR); Chu Hyun Cho, Gyeongsangnam-do (KR); Jong Soo Kim, Gyeongsangnam-do (KR); Young Bae Kim, Gyeongsangnam-do (KR); Hong Je Ryoo, Gyeongsangnam-do (KR)

(73) Assignee: Korea Electrotechnology Research Institute, Gyeongsangnam-do (KR)

(21) Appl. No.: 12/962,239

(22) Filed: Dec. 7, 2010

(51) Int. Cl. H01T 23/00

(52) U.S. Cl. 361/230

(57) ABSTRACT

The present invention provides an apparatus and method for generating an electric discharge in a liquid using a gas jet, in which a gas channel is formed between conductive members in a liquid using high pressure gas jet injection to reduce a discharge voltage in the liquid to a level similar to that in air, thus facilitating the electric discharge in the liquid.

According to the present invention, a gas jet is repeatedly or periodically injected by controlling the opening and closing time of a pneumatic valve while a high voltage is applied, and thus the pneumatic valve serves as a high voltage pulse switch, which makes it possible to generate an electric discharge in a liquid without the use of the expensive high voltage pulse switch (or pulse power supply unit)

Therefore, it is possible to reduce the capacity of the power supply unit for generating the discharge voltage and the manufacturing cost of the apparatus and increase the durability of the conductive members where a spark is generated during discharge.

### BACKGROUND

(a) Technical Field

The present invention relates to an apparatus and method for generating an electric discharge in a liquid using a gas jet and, more particularly, to an apparatus and method for generating an electric discharge between electrodes in a liquid using a gas jet.

(b) Background Art

An electric discharge in a liquid is expected to be effectively used in various industrial fields. Various techniques for using the electric discharge in the liquid to decompose and purify harmful components in industrial wastewater, landfill wastewater, and liquid industrial waste have been developed, and a technique for generating an electric discharge in a liquid has been used to treat ballast water of a vessel.

In an electric discharge where a high temperature circumstance is formed instantaneously, a shock wave may be generated by the electric discharge. Especially, if the electric discharge in the liquid is generated by applying a voltage higher than the electrical breakdown voltage of the liquid, a high shock wave may be formed instantaneously by the electric discharge. Therefore, a method for recycling construction wastes by removing concrete from sand and gravel using the high shock wave have been developed.

However, the electrical breakdown voltage in the liquid is several tens to several hundred times higher than that in air, and thus it is very difficult to generate the electric discharge in the liquid.

Moreover, since there is a significant difference in discharge conditions according to the electrical properties of the liquid, it is necessary to apply an electric field of several to several tens of MV/m or higher between electrodes instantaneously to generate the electric discharge in the liquid.

To apply an electric field of several to several tens of MV/m or higher between the electrodes instantaneously, a pulse power supply unit which can generate an ultra-high voltage is required, which increases the size and manufacturing cost of the overall system.

Furthermore, ultra-high voltage may cause problems such as the generation of corona and x-rays, the risk of electrocution, etc

To solve these problems, a technique for reducing a discharge voltage by injecting air bubbles into the electrodes has been proposed. However, since the air bubbles are formed in a part of the discharge space, the dielectric breakdown voltage in the liquid is still higher than that in the air, and further it is difficult to control the distribution of air bubbles occupying a part of the discharge space.

The above information disclosed in this Background section is only for enhancement of understanding of the background of the invention and therefore it may contain information that does not form the prior art that is already known in this country to a person of ordinary skill in the art.

### SUMMARY OF THE DISCLOSURE

The present invention has been made in an effort to solve the above-described problems associated with prior art. Accordingly, the present invention provides an apparatus and method for generating an electric discharge in a liquid using a gas jet, in which a gas channel is formed between conductive members in a liquid using high pressure gas jet injection to reduce a discharge voltage in the liquid to a level similar to that in air, thus facilitating the electric discharge in the liquid.

In one aspect, the present invention provides a method for generating an electric discharge in a liquid, the method comprising: forming a gas channel by injecting a gas jet between a pair of conductive members in a liquid to which a high voltage is applied; and generating an electric discharge in the gas channel at a discharge voltage similar to or less than that in air.

In another aspect, the present invention provides an apparatus for generating an electric discharge in a liquid, the apparatus comprising: a pair of conductive members being in contact with a liquid; a gas supply unit for injecting a gas jet from the conductive member on one side to the conductive member on the other side; and a power generator for supplying a high voltage to the pair of conductive members.

### BRIEF DESCRIPTION OF THE DRAWINGS

The above and other features of the present invention will now be described in detail with reference to certain exemplary embodiments thereof illustrated the accompanying drawings which are given hereinbelow by way of illustration only, and thus are not limitative of the present invention, and wherein:

FIG. 1 is a schematic diagram showing an apparatus for generating an electric discharge in a liquid in accordance with a preferred embodiment of the present invention;

FIG. 2 is a schematic diagram showing an apparatus for generating an electric discharge in a liquid in accordance with another preferred embodiment of the present invention; and

FIG. 3 is a schematic diagram showing an apparatus for generating an electric discharge in a liquid in accordance with still another preferred embodiment of the present invention.

### DETAILED DESCRIPTION

Hereinafter, preferred embodiments of the present invention will be described in detail with reference to the accompanying drawings.

The terms used in the present specification are merely used to describe particular embodiments and are not intended to limit the present invention. An expression used in the singular encompasses the expression of the plural, unless it has a clearly different meaning in the context.

A plurality of embodiments of the present invention will be described below with reference to the accompanying drawing. In the description, as to the same components as those of prior art, a repetitive description thereof may be omitted.

The present invention provides an apparatus and method for generating an electric discharge in a liquid using a gas jet, in which a gas jet with high flow velocity and density is injected into a discharge space in a liquid at a high pressure such that the discharge space in the liquid is under discharge conditions as those in air to reduce a discharge voltage in the liquid to a level similar to that in the air, thus facilitating the electric discharge in the liquid.

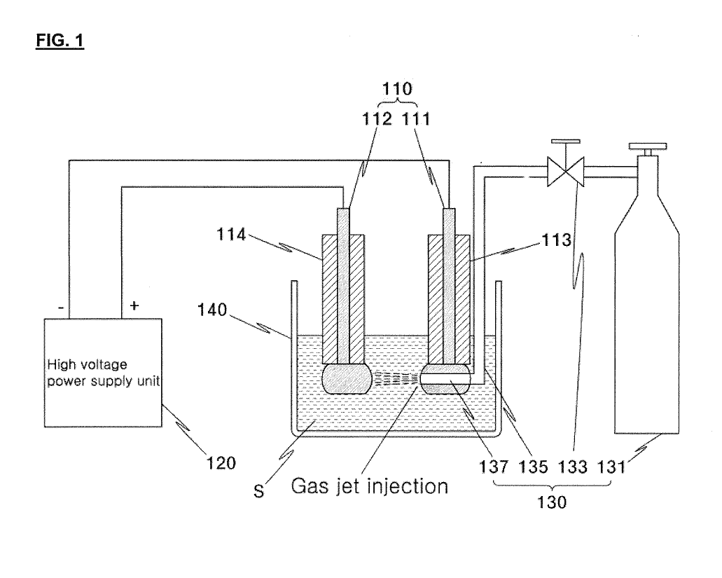

FIG. 1 is a schematic diagram showing an apparatus for generating an electric discharge in a liquid in accordance with a preferred embodiment of the present invention.

As shown in FIG. 1, the apparatus for generating an electric discharge in a liquid in accordance with a preferred embodiment of the present invention may comprise a pair of electrodes 110 configured to be immersed in a liquid, a power generator 120 for supplying a high voltage to the electrodes 110, a gas supply unit 130 for supplying a high pressure gas through a nozzle 137 mounted in one electrode 111, and insulators 113 and 114 for surrounding the outer circumferences of the electrodes 110.

The electrodes 110 are configured to be partially immersed in a liquid S to generate an electric discharge when electric power is supplied, and the nozzle 137 for injecting a gas jet is mounted in the first electrode 111 disposed on the right side of FIG. 1.

The insulators 113 and 114 surround the electrodes 110 except for at least a discharge surface on which the electric discharge is generated.

The gas supply unit 130 may comprise a gas tank 131 for storing a high pressure gas, a pneumatic valve 133 for controlling the flow of the high pressure gas by opening and closing an inlet of the gas tank 131, and a gas pipe 135 for guiding the flow of the high pressure gas. The nozzle 137 is provided to allow the high pressure gas discharged from the gas supply unit 130 to be injected as a gas jet with high flow velocity and density.

While the gas pipe 135 is formed of a plastic material, the nozzle 137 may be mounted in the first electrode 111, which is connected to a negative electrode of the power generator 120 or to the ground, in order to prevent induction of the high voltage from the power generator 120

Reference numeral 140 in FIG. 1 denotes a chamber containing the liquid S in which the electrodes 110 are immersed.

In the apparatus for generating an electric discharge in a liquid according to the present invention, when a gas jet is injected through the nozzle 137 mounted in the first electrode 111 while a high voltage is applied to the second electrode 112 immersed in the liquid S, the electrical breakdown between the electrodes 110 spaced apart from each other at a regular interval in the liquid S is caused, and thus an electric discharge in the liquid is generated between the electrodes 110.

Here, the gas jet injected through the nozzle 137 is directed to the second electrode 112, and thus a gas channel having discharge conditions similar to those in air is formed between the electrodes 110. As a result, the discharge voltage for the electric discharge in the liquid is reduced to a level similar to that in the air, thus reducing the required power.

Moreover, since the electric discharge is generated at a low voltage comparable to the discharge voltage in the air, the durability of the electrodes 110 can be increased.

As such, when the gas jet is repeatedly or periodically injected by controlling the opening and closing time of the pneumatic valve 133 while a high DC voltage is applied, the pneumatic valve 133 serves as a switch, which makes it possible to generate a pulse discharge in a liquid.

Typically, a high pressure pulse voltage is applied to generate the electric discharge in the liquid. The pneumatic valve 133 serves as a high voltage pulse switch required at this time, and thus the apparatus for generating an electric discharge in a liquid according to the present invention can eliminate the expensive high voltage switch, which contributes to a reduction in manufacturing cost of the power supply unit.

Moreover, the present invention controls the operation time of the power generator 120 and that of the pneumatic valve 133 in synchronization with each other, thus improving the consumption efficiency of high voltage and high pressure gas.

In more detail, by opening the pneumatic valve 133 to inject a gas jet, just before high voltage pulse is applied to the second electrode 112, it is possible to reduce discharge voltage in the liquid. Moreover, by closing the pneumatic valve 133 when the electric discharge is turned off (i.e., stopped), the consumption of gas can be reduced.

The above-described operation control, i.e., the synchronization or time delay between the application time of the high voltage pulse and the injection time of the gas jet (or the operation time of the power generator 120 and that of the pneumatic valve 133) can be easily implemented by a delay generator.

Otherwise, the operation control can be implemented by a controller for controlling the operation of the power generator 120 and the pneumatic valve 133.

The present invention can control the discharge characteristics (such as the discharge voltage, discharge shape, etc.) according to the type and pressure of gas injected through the nozzle 137 of the gas supply unit 130.

For example, when a gas having a low ionization energy such as helium, argon, etc. is used, it is possible to apply the discharge voltage between the electrodes 110 at a level lower than the atmospheric pressure. Here, the liquid S around the electrodes 110 serves as a protective barrier for maintaining the electric discharge to prevent the gas from being mixed with other gases, especially with oxygen.

Moreover, the amount of liquid removed from the space between the first electrode 111 and the second electrode 112 can be controlled according to the injection pressure (or flow velocity) of the gas jet supplied by the gas supply unit 130, and thus the amount of liquid present in the gas channel can be controlled. As a result, it is possible to form a gas channel, which is mixed with a very small amount of liquid and is less affected by the liquid, and a gas channel, which is mixed with a relatively large amount of liquid and is much affected by the liquid, thus controlling various discharge characteristics.

The discharge plasma generated in the above manner may be a mixed plasma of gas and liquid (i.e., two phase plasma), and the types of radicals produced during discharge may be increased. Therefore, the discharge plasma can be used for the treatment of various liquids (e.g., wastewater treatment).

In the existing electric discharge in the liquid, the condition for initiating the electric discharge (i.e., discharge initiation voltage) is changed according to the state of the liquid to be treated (e.g., conductivity, impurity concentration, etc.), and thus it is difficult to meet the specifications of the power supply unit. On the contrary, in the apparatus for generating an electric discharge in a liquid according to the present invention, the gas jet is injected into a gap between the pair of electrodes 110 such that the high pressure gas fills the gap between the electrodes 110 to form a gas channel which is less affected by the liquid state, thus generating a stable electric discharge. Therefore, it is possible to optimize the specifications of the power supply unit for initiating or generating the discharge, which is advantageous in terms of cost.

Meanwhile, in the following description of other embodiments of the present invention, as to the same components as those of the above-described embodiment, a repetitive description thereof may be omitted.

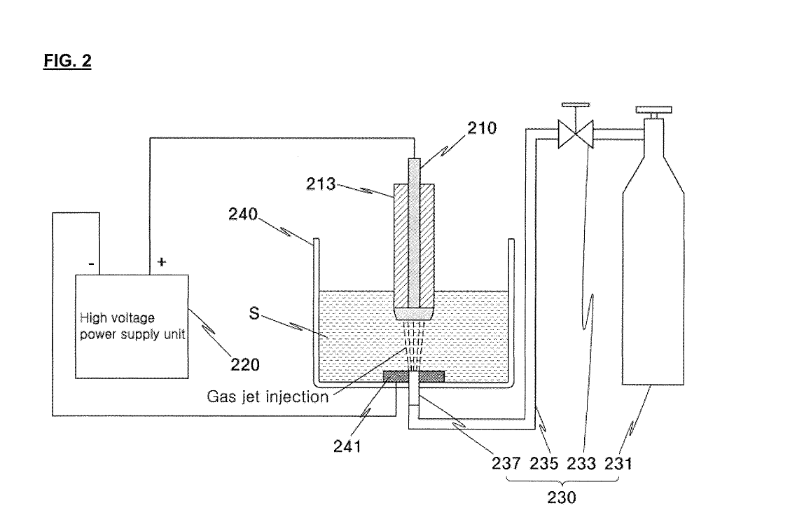

FIG. 2 is a schematic diagram showing an apparatus for generating an electric discharge in a liquid in accordance with another preferred embodiment of the present invention.

As shown in FIG. 2, the apparatus for generating an electric discharge in a liquid in accordance with another preferred embodiment of the present invention is configured to generate an electric discharge between a high pressure electrode 210 and a grounded chamber 240. The apparatus for generating an electric discharge in a liquid in accordance with this embodiment of the present invention may comprise a conductive chamber 240 containing a liquid S, a single electrode 210 configured to be immersed in the liquid S, a power generator 220 for supplying a high voltage between the electrode 210 and the conductive chamber 240, a gas supply unit 230 for supplying a high pressure gas through a nozzle 237 mounted on one side of the conductive chamber 240, and an insulator 213 for surrounding the outer circumference of the electrode 210.

Moreover, a fixing member 241 for fixedly supporting the end of the nozzle 237 configured to penetrate the conductive chamber 240 on the inner surface (e.g., bottom surface) of the conductive chamber 240 is provided. Preferably, the fixing member 241 may be formed of a conductive material to generate the electric discharge between the electrode 210 and the conductive chamber 240.

The conductive chamber 240 is connected to a negative electrode of the power generator 220 or to the ground, and the high voltage may be applied through the electrode 210 to prevent the gas supply unit 230 from being induced the high voltage.

According to the above-described configuration, it is possible to generate an electric discharge in a liquid at a discharge voltage similar to that in air by injecting a gas jet from the conductive chamber 240 to the electrode 210.

Moreover, in the apparatus for generating an electric discharge in a liquid having the configuration of FIG. 2, the injection length of the gas jet may be increased to generate an electric discharge in a liquid over a long gap, and thus a strong shock wave can be obtained in the liquid.

As mentioned above, in an electric discharge where a high temperature circumstances is formed instantaneously, a shock wave may be generated by the electric discharge. Especially, if the electric discharge in the liquid is formed at a voltage higher than the electrical breakdown voltage of the liquid, a high shock wave may be generated instantaneously by the electric discharge.

Therefore, the apparatus for generating an electric discharge in a liquid according to the present invention can be used to recycle construction wastes or treat ballast water of a vessel.

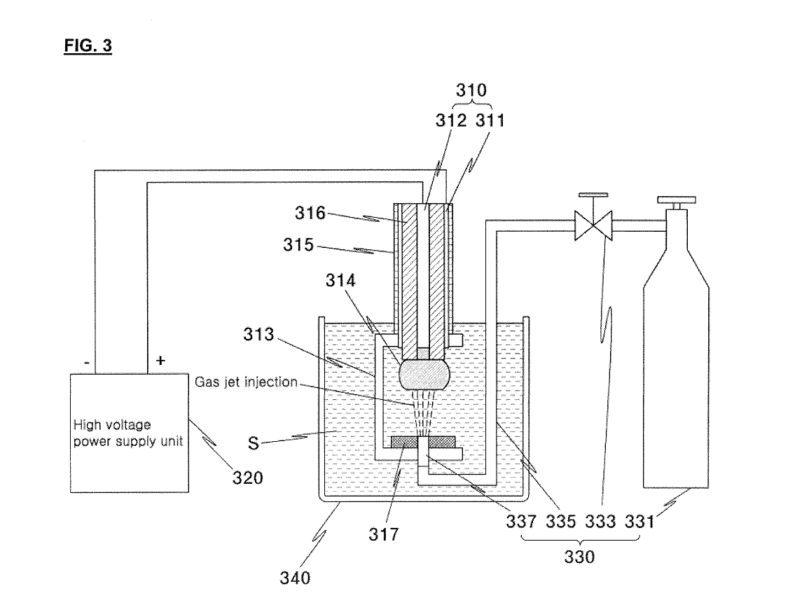

FIG. 3 is a schematic diagram showing an apparatus for generating an electric discharge in a liquid in accordance with still another preferred embodiment of the present invention.

As shown in FIG. 3, the apparatus for generating an electric discharge in a liquid in accordance with still another preferred embodiment of the present invention is configured to facilitate the electric discharge in the liquid using a gas jet by connecting electrodes 313 and 314 to a coaxial cable 310 to form a pair of conductive members for generating the electric discharge. The apparatus for generating an electric discharge in a liquid in accordance with this embodiment of the present invention may comprise a coaxial cable 310 configured such that one side thereof is immersed in a liquid S contained in a chamber 340, an external electrode 313 connected to an external conductor 311 of the coaxial cable 310, a power generator 320 for supplying a high voltage, and a gas supply unit 330 for supplying a high pressure gas through a nozzle 337 mounted on the external electrode 313.

An internal electrode 314 with a discharge surface having a sufficient area to receive the gas jet injected through the nozzle 337 is connected to an internal conductor 312 of the coaxial cable 310, thus serving as one conductive member, and the external electrode 313 connected to the external conductor 311 serves as the other conductive member.

Moreover, insulators 315 and 316 for surrounding the outer circumferences of the internal conductor 312 and the external conductor 311 of the coaxial cable 310 are provided.

Here, the external electrode 313 has an open loop shape with one open side, and the nozzle 337 for injecting a gas jet is provided at a position (e.g., on one side of the external electrode 313) facing a region (e.g., the other side of the external electrode 313) where the external conductor 311 of the coaxial cable 310 is connected.

Moreover, a fixing member 317 for fixedly supporting the end of the nozzle 337 on the one side of the external electrode 313 may be formed of a conductive material for the electric discharge.

Preferably, the high voltage supplied to generate the electric discharge in this embodiment may be applied to the internal conductor 312 of the coaxial cable 310 and the internal electrode 314, where the nozzle 337 is not provided.

Also, in the apparatus for generating an electric discharge in a liquid according to this embodiment of the present invention, while the high voltage is applied from the power generator 320, the high pressure gas supplied by the gas supply unit 330 is injected through the nozzle 337 as a gas jet at a constant flow velocity to form a gas channel, thus generating an electric discharge in a liquid in the gas channel at a discharge voltage similar to that in air.

In the apparatus for generating an electric discharge in a liquid using the coaxial cable 310 shown in FIG. 3, the coaxial cable 310 integrally connected to the external electrode 313 and the internal electrode 314, to which the high voltage is applied, can freely move in the liquid. Therefore, the apparatus according to this embodiment can generate the electric discharge in the liquid over a wide region where the electric discharge is required and thus can be used in various fields.

The operation of the apparatus according to the embodiments shown in FIGS. 1 to 3 will be described below.

While the high voltage is applied through the power generator 120, 220 or 320, the high pressure gas of the gas tank 131, 232 or 331 is injected through the nozzle 137, 237 or 337 as a gas jet to form a gas channel between the first electrode 111 and the second electrode 112, between the electrode 210 and the conductive chamber 240, or between the external electrode 313 and the internal electrode 314, thus generating an electric discharge in a liquid in the gas channel at a discharge voltage similar to that in air.

Here, the injection of the gas jet is repeatedly carried out by the opening and closing of the pneumatic valve 133, 233 or 333, and thus the present invention can obtain the effect that the high voltage pulse voltage is applied.

Otherwise, the time when electric power is applied to the conductive members 110, 210, or 310 immersed in the liquid and the time when the pneumatic valve 133, 233 or 333 is opened and closed may be synchronized with each other or delayed with respect to each other, thus increasing the efficiency of the apparatus.

According to the present invention, a gas jet with high flow velocity and density is injected into the discharge space in the liquid, instead of air bubbles, to reduce the discharge voltage in the liquid to a level similar to that in the air, thus facilitating the electric discharge in the liquid. Therefore, it is possible to control the discharge initiation voltage by modifying the structure of the nozzle 137, 237 or 337 for injecting the gas jet, the type and pressure of the injection gas, and the injection type. Moreover, it is possible to control the shape of the electric discharge to provide various current effects, and further it is possible to reduce the power capacity and manufacturing cost.

In addition, the electrodes 110 and 210, the conductive chamber 240, the coaxial cable 310, the external electrode 313, and the internal electrode 314 configured according to the embodiments of the present invention are the conductive members, to which the high voltage supplied by the power generators 120, 220 and 320 is applied, and may be configured in various forms.

As described above, according to the present invention, a gas jet is injected into a gap between a pair of conductive members in a liquid to form a gas channel having discharge conditions similar to those in air such that the discharge voltage in the liquid is reduced to a level similar to that in the air, thus facilitating the electric discharge in the liquid.

Moreover, when the gas jet is repeatedly or periodically injected by controlling the opening and closing time of a pneumatic valve while a high voltage is applied, the pneumatic valve serves as a high voltage switch, and thus it is possible to generate an electric discharge in a liquid without the use of the expensive high voltage pulse switch (or pulse power supply unit).

Furthermore, the time when electric power is applied to the conductive members and the time when the pneumatic valve is opened and closed are synchronized with each other or delayed with respect to each other, thus increasing the efficiency of the apparatus.

Therefore, it is possible to reduce the capacity of the power supply unit for generating the discharge voltage and the manufacturing cost of the apparatus and increase the durability of the conductive members where a spark is generated during discharge.

Moreover, it is possible to reduce the generation of corona and x-rays, the risk of electrocution, etc. due to the high voltage.

In addition, it is possible to control the discharge initiation voltage by modifying the structure of the nozzle for injecting the gas jet, the type and pressure of the injection gas, and the injection type.

Additionally, it is possible to control the distribution of liquid and gas in the discharge space by adjusting the shape of the electric discharge, thus effectively using the discharge plasma.

The invention has been described in detail with reference to preferred embodiments thereof. However, it will be appreciated by those skilled in the art that changes may be made in these embodiments without departing from the principles and spirit of the invention, the scope of which is defined in the appended claims and their equivalents.

What is claimed is:

1. A method for generating an electric discharge in a liquid, the method comprising:
forming a gas channel by injecting a gas jet between a pair of conductive members in a liquid to which a high voltage is applied; and
generating an electric discharge in the gas channel at a discharge voltage similar to that in air.

2. The method of claim 1, wherein the gas jet is repeatedly injected to generate a pulse discharge.

3. The method of claim 1, wherein the gas jet is injected before or when the high voltage is applied.

4. The method of claim 1, wherein the injection of the gas jet is stopped when the electric discharge in the liquid is stopped.

5. The method of claim 1, wherein the type of the gas jet is changed or the injection pressure is adjusted to control a discharge initiation voltage.

6. The method of claim 5, wherein the gas jet is formed using a high pressure gas having a low ionization energy such that the discharge voltage is reduced to a level lower than the atmospheric pressure.

7. The method of claim 1, wherein the gas jet is injected from a conductive member connected to a ground.

8. An apparatus for generating an electric discharge in a liquid, the apparatus comprising:
a pair of conductive members being in contact with a liquid;
a gas supply unit for injecting a gas jet from the conductive member on one side to the conductive member on the other side; and
a power generator for supplying a high voltage to the pair of conductive members.

9. The apparatus of claim 8, wherein the gas supply unit comprises:
a gas tank for storing a high pressure gas;
a nozzle mounted in the conductive member on one side to inject a gas jet to the conductive member on the other side;
a gas pipe for supplying the high pressure gas in the gas tank to the nozzle; and
a pneumatic valve for controlling the flow of the high pressure gas.

10. The apparatus of claim 9, wherein the nozzle is mounted in the conductive member connected to a ground.

11. The apparatus of claim 8, further comprising an insulator for surrounding the outer circumference of each of the conductive members.

12. The apparatus of claim 8, wherein the pair of conductive members comprises a conductive chamber containing a liquid and an electrode.

13. The apparatus of claim 8, wherein the pair of conductive members comprises an internal electrode connected to an internal conductor of a coaxial cable and an external electrode connected to an external conductor of the coaxial cable.

14. The apparatus of claim 13, wherein the external electrodes has an open loop shape with one open side.

15. The apparatus of claim 8, further comprising a delay generator for synchronizing or delaying the operation time of the power generator and that of the pneumatic valve.

16. The method of claim 3, wherein the injection of the gas jet is stopped when the electric discharge in the liquid is stopped.
